(19) United States
(12) Patent Application Publication
(10) Pub. No.: US 2025/0239616 A1
(43) Pub. Date: Jul. 24, 2025

(54) CATHODE MIXTURE AND BATTERY

(71) Applicant: TOYOTA JIDOSHA KABUSHIKI KAISHA, Toyota-shi (JP)

(72) Inventor: Heidyhodex VISBALMENDOZA, Nagoya-shi (JP)

(73) Assignee: TOYOTA JIDOSHA KABUSHIKI KAISHA, Toyota-shi (JP)

(21) Appl. No.: 19/016,549

(22) Filed: Jan. 10, 2025

(30) Foreign Application Priority Data
Jan. 19, 2024 (JP) 2024-006824

(51) Int. Cl. H01M 4/62; H01M 4/131; H01M 4/36; H01M 10/0562; H01M 10/42

(52) U.S. Cl. CPC H01M 4/625; H01M 4/131; H01M 4/366; H01M 10/0562; H01M 10/425; H01M 2300/0068; H01M 2300/0071

(57) ABSTRACT

A main object of the present disclosure is to provide a cathode mixture capable of suppressing an increase in resistance caused by an increase in potential of a cathode active material layer. The present disclosure achieves the object by providing a cathode mixture comprising a cathode active material, a first solid electrolyte, a first conductive material which is a particulate carbon material, and a second conductive material which is a fibrous carbon material.

### TECHNICAL FIELD

The present disclosure relates to a cathode mixture and a battery.

### BACKGROUND ART

The solid-state battery comprises an electrolyte layer including a solid electrolyte between a cathode active material layer and an anode active material layer. The cathode active material layer contains at least a cathode active material and may further contain a solid electrolyte that improves ionic conductivity and a conductive material that improves electronic conductivity.

For example, Patent Literature 1 discloses a cathode material comprising a mixture of a cathode active material, a solid electrolyte and a conductive material, wherein the conductive material comprises a first conductive material having an average long axis diameter of 1 μm or more, and a second conductive material having an average particle diameter of more than 23 nm and 100 nm or less, and wherein a ratio of a volume of the cathode active material to a total volume of the cathode active material and the solid electrolyte is 50% or more and 90% or less. Further, Patent Literature 2 discloses a cathode for all solid state battery comprising a molded body of a cathode mixture containing a cathode active material, a sulfide based solid electrolyte, and a conductive aid, wherein the molded body contains a fibrous carbon and a granular carbon as the conductive aid, and the molded body of the cathode mixture has a thickness of 250 μm or more.

### CITATION LIST

### Patent Literatures

Patent Literature 1: International Publication No. 2023/132303
Patent Literature 2: Japanese Patent Application Laid-Open (JP-A) No. 2021-144906

### SUMMARY OF DISCLOSURE

### Technical Problem

Since a solid electrolyte is less prone to oxidative decomposition than a typical electrolyte solution, a cathode active material layer including a solid electrolyte can be brought to a high potential at the time of charging, and as a result, a battery having a large voltage can be obtained. On the other hand, when the cathode active material layer has a high potential, a resistance is likely to be increased.

The present disclosure has been made in view of the above circumstances, and a main object of the present disclosure is to provide a cathode mixture capable of suppressing an increase in resistance caused by an increase in potential of a cathode active material layer.

### Solution to Problem

[1]

A cathode mixture comprising a cathode active material, a first solid electrolyte, a first conductive material which is a particulate carbon material, and a second conductive material which is a fibrous carbon material,
D/G ratio of the first conductive material is 1.0 or less,
D/G ratio of the second conductive material is 0.5 or less, and
a ratio of the first conductive material to a total of the first conductive material and the second conductive material is 5% by mass or more and 30% by mass or less.
   [2]

The cathode mixture according to [1], wherein the ratio of the first conductive material to the total of the first conductive material and the second conductive material is 8% by mass or more and 20% by mass or less.

[3]

The cathode mixture according to [1] or [2], wherein the first solid electrolyte is a sulfide solid electrolyte, and
the cathode active material is coated by a second solid electrolyte which is an oxide solid electrolyte.
   [4]

A battery comprising a cathode active material layer, an anode active material layer, and an electrolyte layer disposed between the cathode active material layer and the anode active material layer,
wherein the cathode active material layer comprises the cathode mixture according to any one of [1] to [3].
   [5]

The battery according to [4], wherein the battery includes a control device configured to control a potential of the cathode active material layer to be equal to or higher than 4.0V (vs. Li/Li⁺) during charge.

### Advantageous Effects of Disclosure

The cathode mixture in the present disclosure is effective in suppressing an increase in resistance caused by an increase in potential of a cathode active material layer.

### BRIEF DESCRIPTION OF DRAWINGS

FIG. 1 is an enlarged schematic cross-sectional view of a portion of a cathode mixture in the present disclosure.

FIG. 2 is a schematic cross-sectional view illustrating a cathode active material in the present disclosure.

FIG. 3 is a schematic cross-sectional view illustrating a battery in the present disclosure.

### DESCRIPTION OF EMBODIMENTS

Hereinafter, a cathode mixture and a battery according to the present disclosure will be described with reference to the drawings. Each of the drawings shown below is schematically shown, and the size and shape of each part are appropriately exaggerated for ease of understanding.

### A. Cathode Mixture

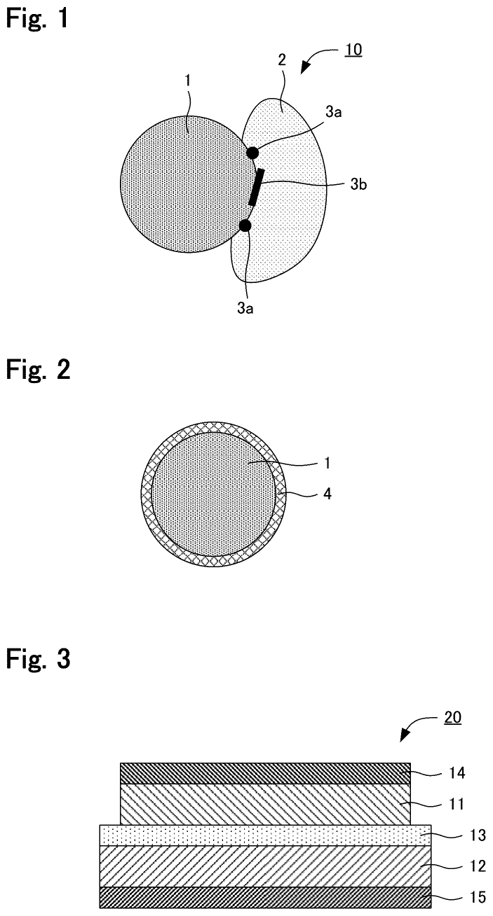

FIG. 1 is an enlarged schematic cross-sectional view of a portion of a cathode mixture in the present disclosure. As shown in FIG. 1, cathode mixture 10 includes a cathode active material 1, a first solid electrolyte 2, a first conductive material 3a that is a particulate carbon material, and a second conductive material 3b that is a fibrous carbon material. D/G ratio of the first conductive material 3a and the second conductive material 3b are within a predetermined range. In addition, the mass ratio of the first conductive material 3a to a total of the first conductive material 3a and the second conductive material 3b is within a predetermined range.

According to the present disclosure, by combining the predetermined first conductive material and the predetermined second conductive material at a predetermined ratio, a cathode mixture capable of suppressing an increase in resistance caused by an increase in potential of a cathode active material layer is obtained. As described above, a solid electrolyte is less prone to oxidative decomposition than a typical electrolyte solution, a cathode active material layer including a solid electrolyte can be brought to a high potential at the time of charging, and as a result, a battery having a large voltage can be obtained. On the other hand, when the cathode active material layer has a high potential, a resistance is likely to be increased. Compared to that, according to the present disclosure, the first conductive material, which is a particulate carbon material, having a low D/G ratio, and the second conductive material, which is a fibrous carbon material, having a low D/G ratio are used in combination at a predetermined ratio, so that it is possible to suppress an increase in resistance caused by an increase in the potential of the cathode active material layer. Since the material with a low D/G ratio have fewer defects, a side reaction is unlikely to occur even when the electric potential of the cathode active material layer is high.

### 1. Conductive Material

A cathode mixture in the present disclosure includes, as the conductive material, a first conductive material that is a particulate carbon material and a second conductive material that is a fibrous carbon material.

The first conductive material is a particulate carbon material. Examples of the particulate carbon material include acetylene black (AB) and ketjen black (KB). The particulate carbon material may be a primary particle or a secondary particle in which primary particles are aggregated. The average particle diameter of the first conductive material is, for example, 10 nm or more and 5 μm or less, and may be 60 nm or more and 200 nm or less. The average particle size herein refers to the volume cumulative particle size D50 measured by a laser diffraction-scattering particle size analyzer.

In Raman spectroscopy, the ratio of the intensity of the D-band (the peak near 1346 cm-1) to the intensity of the G-band (the peak near 1577 cm-1) is referred to as D/G ratio. The G-band is a peak derived from in-plane vibration of the six-membered ring of carbon, and the D-band is a peak derived from a defect. Therefore, a low D/G ratio means that the number of defects is small. D/G ratio of the first conductive material is usually 1.0 or less, and may be 0.8 or less. Examples of the conditions for Raman spectroscopy include a condition in which a Raman spectrophotometer (DXR3xi Imaging Micro-Raman, manufactured by Yamato Scientific Co., Ltd.) is used to set the laser energy to 1.5 mW, the exposure time to 50 Hz, and the number of scans to 50.

The first conductive material may be uniformly disposed or non-uniformly disposed in a cathode mixture. In particular, it is preferable that the first conductive material is disposed so as to cover a cathode active material directly or through another layer (for example, a second solid electrolyte described later). When the mass of the first conductive material in a cathode mixture is M_{T} and the mass of the first conductive material covering a cathode active material is M₁, the ratio of M₁ to M_{T} is, for example, 50% by mass or more, may be 70% by mass or more, or may be 90% by mass or more.

The second conductive material is a fibrous carbon material. Examples of the fibrous carbon material include carbon fiber (CF), carbon nanotube (CNT), and carbon nanofiber (CNF). The carbon nanotube (CNT) may be a single-walled carbon nanotube (SWNT) or multi layer-walled carbon nanotube (MWNT). The average diameter of the second conductive material is, for example, 1 nm or more and 50 nm or less. The average length of the second conductive material is, for example, 500 nm or more and 50 μm or less.

D/G ratio of the second conductive material is usually 0.5 or less, and may be 0.4 or less. D/G ratio of the second conductive material is preferably smaller than D/G ratio of the first conductive material. The second conductive material may be uniformly disposed or non-uniformly disposed in a cathode mixture. In particular, it is preferable that the first conductive material is disposed so as to cover a cathode active material directly or through another layer (for example, a second solid electrolyte described later), and the second conductive material is disposed uniformly in a cathode mixture.

When the electronic conductivity of the first conductive material (25° C.) is C₁ and the electronic conductivity of the second conductive material (25° C.) is C₂, the ratio of C₁ to C₂ is, for example, 1.0 or less, may be 0.8 or less, may be 0.6 or less. Further, when the powder resistance of the first conductive material is r₁, and the powder resistance of the second conductive material is r₂, the ratio of r₁ to r₂ is, for example, 1.0 or more, may be 1.3 or more, may be 1.6 or more.

The ratio of the first conductive material to the total of the first conductive material and the second conductive material is, for example, 5% by mass or more and 30% by mass or less, and may be 8% by mass or more and 20% by mass or less. The ratio of the first conductive material in a cathode mixture (solid content) is, for example, 0.1% by mass or more and 5% by mass or less, and may be 0.5% by mass or more and 3% by mass or less. The ratio of the second conductive material in a cathode mixture (solid content) is, for example, 0.1% by mass or more and 5% by mass or less, and may be 0.5% by mass or more and 3% by mass or less.

The ratio of the total of the first conductive material and the second conductive material in a cathode mixture (solid content) is not particularly limited, but it is, for example, 10% by mass or less, may be 8% by mass or less, may be 6% by mass or less, 4% by mass or less. On the other hand, the ratio of the total of the first conductive material and the second conductive material is, for example, 1% by mass or more.

### 2. First Solid Electrolyte

Examples of the first solid electrolyte in the present disclosure include inorganic solid electrolytes such as a sulfide solid electrolyte, an oxide solid electrolyte, a nitride solid electrolyte, a halide solid electrolyte, and a complex hydride. Among them, the sulfide solid electrolyte is particularly preferable. This is because the ionic conductivity is high. The sulfide solid electrolyte usually contains sulphur(S) as the main component of the anionic element. The oxide solid electrolyte, the nitride solid electrolyte, and the halide solid electrolyte usually contain oxygen (O), nitrogen (N), and halogen (X) as main components of the anionic element, respectively.

The sulfide solid electrolyte preferably contains, for example, a Li element, a X element (X is at least one of P. As, Sb, Si, Ge, Sn, B, Al, Ga, In), and a S element. Also, the sulfide solid electrolyte may further include at least one of an O element and a halogen element. It is preferable that the sulfide solid electrolyte contains a S element as a main component of an anionic element.

Examples of sulfide solid electrolyte include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, Z is any of Ge, Zn, Ga), Li₂S—GeS₂, Li₂S—SiS₂—Li₃PO₄, Li₂S—SiS₂—LiₓMO_{y} (where x and y are positive numbers, and M is any of P, Si, Ge, B, and Al, Ga, In).

The first solid electrolyte may be glass and may have a crystal phase. Examples of the crystal phase include Thio-LISICON type crystal phase, argyrodite type crystal phase, and LGPS type crystal phase. The shape of the first solid electrolyte is usually particulate. The average particle diameter of the first solid electrolyte is, for example, 0.01 μm or more. Meanwhile, the average particle diameter of the first solid electrolyte is, for example, 10 μm or less, and may be 5 μm or less. Further, the ionic conductivity of the first solid electrolyte at 25° C. is, for example, 1*10-4 S/cm or more, and may be 1*10⁻³ S/cm or more.

The ratio of the first solid electrolyte in a cathode mixture (solid content) is not particularly limited, but it is, for example, 30% by mass or more and 70% by mass or less, and may be 40% by mass or more and 60% by mass or less.

### 3. Cathode Active Material

An example of the cathode active material in the present disclosure includes an oxide active material. Examples of the oxide active material include a rock salt layered active material such as LiCoO₂, LiNi_{1/3}Co_{1/3}Mn_{1/3}O₂, a spinel-type active material such as LiMn₂O₄, LiNi_{0.5}Mn_{1.5}O₄, Li₄Ti₅O₁₂, and an olivine-type active material such as LiFePO₄.

As shown in FIG. 2, cathode active material 1 is preferably coated on second solid electrolyte 4. This is because it is possible to prevent the cathode active material (particularly, the oxide active material) from reacting with the first solid electrolyte (particularly, the sulfide solid electrolyte) to form a high-resistance layer. An example of the second solid electrolyte includes an oxide solid electrolyte. Examples of the oxide solid electrolyte include LiNbO₃, LiBPO₄, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, Li₂MoO₄, Li₂WO₄. The coverage (area ratio) of the oxide solid electrolyte is, for example, 70% or more, may be 80% or more, or may be 90% or more. The thickness of the oxide solid electrolyte is, for example, 0.1 nm or more and 100 nm or less, and may be 1 nm or more and 20 nm or less.

The ratio of the cathode active material in a cathode mixture (solid content) is not particularly limited, but it is, for example, 50% by mass or more, may be 60% by mass or more, may be 70% by mass or more, or may be 80% by mass or more.

### 4. Cathode Mixture

A cathode mixture in the present disclosure may contain a binder. Examples of the binder include rubber-based binders such as butylene rubber (BR) and styrene butadiene rubber (SBR); and fluoride-based binders such as polyvinylidene fluoride (PVDF). The ratio of the binder in the cathode mixture (solid content) is not particularly limited, but it is, for example, 5% by mass or less and may be 3% by mass or less.

The cathode mixture may be a powder containing the above-described materials, or may be a slurry in which the above-described materials are dispersed in a dispersing medium. The kind of the dispersion medium is not particularly limited, and a known material can be used. The cathode mixture in the present disclosure is preferably used for a battery.

### B. Battery

FIG. 3 is a schematic cross-sectional view illustrating a battery in the present disclosure. Battery 20 shown in FIG. 3 includes cathode active material layer 11, anode active material layer 12, electrolyte layer 13 disposed between cathode active material layer 11 and anode active material layer 12, cathode current collector 14 that collects current in cathode active material layer 11, and anode current collector 15 that collects current in anode active material layer 12. In addition, cathode active material layer 11 includes the cathode mixture described in “A. Cathode mixture” above.

According to the present disclosure, since the cathode active material layer includes the above-described cathode mixture, the battery, which is suppressing an increase in resistance caused by an increase in potential of the cathode active material layer, is obtained.

### 1. Cathode

A cathode in the present disclosure includes a cathode active material layer, and a cathode current collector. The cathode active material layer includes the cathode mixture described above. The thickness of the cathode active material layer is, for example, 1 μm or more and 500 μm or less. Examples of the cathode current collector include SUS, aluminum, nickel, and carbon. An example of a shape of the cathode current collector includes a foil shape. The thickness of the cathode current collector is, for example, 1 μm or more and 500 μm or less.

### 2. Anode

An anode in the present disclosure includes an anode active material layer, and an anode current collector. The anode active material layer contains at least an anode active material, and may further contains at least one of a conductive material, an electrolyte, and a binder. The anode active material layer preferably contains a solid electrolyte as the electrolyte. Examples of the anode active material include Li-based active materials such as Li, Li alloys; Si-based active materials such as Si, Si alloys; oxide active materials such as Li₄Ti₅O₁₂; and carbon-based active materials such as graphite. The conductive material, the solid electrolyte, and the binder are the same as those described in “A. Cathode mixture” above. The thickness of the anode active material layer is, for example, 1 μm or more and 500 μm or less.

Examples of anode current collector include SUS, copper, nickel, and carbon. An examples of a shape of the anode current collector includes a foil form. The thickness of the anode current collector is, for example, 1 μm or more and 500 μm or less.

### 3. Electrolyte Layer

An electrolyte layer in the present disclosure contains at least an electrolyte. The electrolyte is preferable a solid electrolyte. A battery in which the electrolyte layer contains a solid electrolyte is referred to as a solid-state battery. The solid battery may be an all solid state battery or a semi-solid battery. The solid electrolyte is the same as described in “A. Cathode mixture” above. The electrolyte layer may be a layer containing an electrolyte solution. In addition, the electrolyte layer may contain a binder. The binder is the same as described in “A. Cathode mixture” above. The thickness of the electrolyte layer is, for example, 1 μm or more and 500 μm or less.

### 4. Battery

A Battery in the present disclosure preferably includes a control device configured to control a potential of the cathode active material layer to be equal to or higher than 4.0V (vs. Li/Li⁺) during charge. Even when cathode active material layer has a high potential, the use of the cathode mixture to the cathode active material layer can suppress the increase of resistance. At the time of charging, a potential of the cathode active material layer may be controlled to be equal to or higher than 4.5V (vs. Li/Li⁺). Although the potential of the cathode active material layer is increased by charging, the control device is preferably configured not to stop charging until the potential of cathode active material layer becomes equal to or greater than a predetermined value.

Applications of the battery in the present disclosure are not particularly limited, and examples thereof include power supplies of vehicles such as a hybrid electric vehicle (HEV), a plug-in hybrid electric vehicle (PHEV), a battery electric vehicle (BEV), gasoline-powered vehicles, and diesel-powered vehicles. In particular, it is preferably used for a power supply for driving a hybrid electric vehicle (HEV), a plug-in hybrid electric vehicle (PHEV), or a battery electric vehicle (BEV). The battery may be used as a power source for a moving object (for example, a railroad, a ship, or an airplane) other than vehicles, or may be used as a power source for an electric appliance such as an information processing device.

Further, in the present disclosure, it is also possible to provide a battery comprising a cathode active material layer, an anode active material layer, and an electrolyte layer disposed between the cathode active material layer and the anode active material layer, wherein the cathode active material layer includes a cathode active material, a first solid electrolyte, a first conductive material that is a particulate carbon material, and a second conductive material that is a fibrous carbon material, the ratio of the first conductive material to a total of the first conductive material and the second conductive material is 5% by mass or more and 30% by mass or less, and the battery includes a control device configured to control a potential of the cathode active material layer to be equal to or higher than 4.0V (vs. Li/Li⁺) during charge.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### (Preparation of Cathode)

A cathode active material (LiNi_{1/3}Co_{1/3}Mn_{1/3}O₂) and a second solid electrolyte (LiBPO₄) were charged to a kneader and kneaded 2000 rpm for 2 minutes to obtain a coated active material. Thereafter, so that the content of a first conductive material (particulate carbon material, D/G ratio: 0.9, average particle size D50:75 nm) to be 0.7% by mass, the first conductive material was charged into the kneading machine, and kneaded 2000 rpm for 2 minutes to obtain a coated active material containing the first conductive material. Next, the coated active material containing the first conductive material, and a sulfide solid electrolyte (Li₂S—P₂S₅ glass-ceramics containing LiI, average particle size D50: 0.8 μm) were weighed so that the cathode active material and the sulfide solid electrolyte were in a volume ratio of 7:3, and these materials were charged into heptane together with 2.3% by mass of a second conductive material (fibrous carbon material, D/G ratio: 0.26, fiber diameter: 30 nm, fiber length: 600 nm) and 0.7% by mass of a binder (butadiene rubber). A cathode mixture was then prepared by mixing the above ingredients. The prepared cathode mixture was sufficiently dispersed by an ultrasonic homogenizer (UH-50 manufactured by SMT Co., Ltd) and then coated on a cathode current collector (aluminum foil) and dried at 100° C. for 30 minutes. A cathode having the cathode current collector and the cathode active material layer was then obtained by punching into 1 cm² size.

### <Preparation of Anode>

To a kneading vessel of a filmix device (30-L type manufactured by Primix Co., Ltd.), a sulfide solid electrolyte (Li₂S—P₂S₅ glass-ceramics containing LiI, average particle size D50: 0.8 μm), 1% by mass of a conductive material (vapor grown carbon fiber), 2% by mass of a binder (butadiene rubber), and heptane were charged, and the mixture was stirred at a 20,000 rpm for 30 minutes. Then, an anode active material (Li₄Ti₅O₁₂, average particle size D50=1 μm) was charged into a kneading container so that a volume ratio of the anode active material and the sulfide solid electrolyte was 6:4, and the mixture was stirred in the filmix device under 15,000 rpm for 60 minutes to prepare an anode mixture. The prepared anode mixture was coated on an anode current collector (copper foil) and dried at 100° C. for 30 minutes. An Anode having the anode current collector and the anode active material layer was then obtained by punching into 1 cm².

### (Preparation of Solid Electrolyte Layer)

To a cylindrical ceramic having an inner diameter cross-sectional area 1 cm², a 64.8 mg of a sulfide solid electrolyte (Li₂S—P₂S₅ glass-ceramic containing LiI, average particle diameter D50: 2.5 μm) was placed, smoothed, and pressed with 1 ton/cm² to obtain a solid electrolyte layer.

### (Preparation of Battery)

On one side of the solid electrolyte layer, the cathode was placed, and on another side of the solid electrolyte layer, the anode was placed and pressed with 6 ton/cm² for 1 minute. Stainless bars were then placed on the cathode side and the anode side, respectively, and constrained with 1 ton to obtain a battery.

### Examples 2 to 6

Batteries were obtained in the same manner as in Example 1, except that the contents and kinds of the first conductive material and the second conductive material were changed to those described in Table 1.

### Comparative Example 1

A battery was obtained in the same manner as in Example 1, except that the content of the second conductive material was changed to 3% by mass and not using the first conductive material.

### [Evaluation]

Batteries obtained in Examples 1 to 6 and Comparative Example 1 were subjected to capacity test by constant current-constant voltage charging and discharging at ⅓C rates, and then adjusted to SOC 40% at ⅓C rates. After that, CC discharge was conducted under the condition of current 0.3C and 0.1 second, and the voltage drop (ΔV) and the current (I) at the time of discharge were measured. From the measurement results, an initial battery resistance R (=ΔV/I) was obtained according to Ohm's law. Next, as a durability test, the cathode potential was set to be 4.5V, and trickle charge was performed at 60° C. for 2 weeks. Thereafter, in the same manner as described above, a battery resistance R′ after durability was determined, and the resistance increasing rate was determined. The results are shown in Table 1.

Batteries obtained in Examples 1 to 6 and Comparative Example 1 were subjected to capacity test by constant current-constant voltage charging and discharging at ⅓C rates, and then adjusted to SOC 50% at ⅓C rates. The AC impedance was measured by 10 mV, 0.1 Hz to 10⁶ Hz, the arc was fitted to Cole-Cole plot, and the distance between two points of the intersection of the fitted arc and the real axis was determined as the reactive resistance (initial resistance). The results are shown in Table 1. In Table 1, the initial resistances of Examples 1 to 6 are relative values when the initial resistance of Comparative Example 1 is set to 1.00.

TABLE 1

| | First conductive | | Content “b” | | Resistance | |
|---|---|---|---|---|---|---|
| | material | | of second | | increasing rate | |
| | Content | Average | conductive | | before and after | |
| | “a” | diameter | material | a/(a + b) | durability test | Initial |
| | [mass %] | [nm] | [mass %] | [%] | [%] | resistance |
| Co-Ex. 1 | 0 | — | 3.0 | 0 | 16.5 | 1.00 |
| Ex. 1 | 0.7 | 75 | 2.3 | 23.3 | 9.3 | 1.21 |
| Ex. 2 | 0.5 | 75 | 2.5 | 16.7 | 12 | 0.94 |
| Ex. 3 | 0.3 | 75 | 2.7 | 10.0 | 14 | 0.94 |
| Ex. 4 | 0.7 | 131 | 2.3 | 23.3 | 6.7 | 1.35 |
| Ex. 5 | 0.5 | 131 | 2.5 | 16.7 | 13 | 0.95 |
| Ex. 6 | 0.3 | 131 | 2.7 | 10.0 | 11 | 0.94 |

As shown in Table 1, it is confirmed that the resistance increase rate before and after the durability were lower in Examples 1 to 6 than in Comparative Example 1. In other words, by setting the ratio (a/(a+b)) of the first conductive material to the total of the first conductive material and the second conductive material to a specified range, the cathode mixture capable of suppressing the increase in resistance caused by the increase in the potential of the cathode active material layer is obtained. Further, as in Examples 1 and 4, when (a/(a+b)) is relatively high (e.g. by setting to 20% to 30%), it is confirmed that the resistance increase rate before and after the durability can be greatly reduced. On the other hand, as in Examples 2, 3, 5, and 6, when the ratio (a/(a+b)) of the first conductive material to the total of the first conductive material and the second conductive material is relatively low (e.g., by setting to 8% to 20%), it is confirmed that the reduction of the initial resistance is also achieved.

### REFERENCE SINGS LIST

1 cathode active material
2 first solid electrolyte
3 conductive material
4 second Solid electrolyte
11 cathode active material layer
12 anode active material layer
13 electrolyte layer
14 cathode current collector
15 anode current collector
20 battery

1. A cathode mixture comprising a cathode active material, a first solid electrolyte, a first conductive material which is a particulate carbon material, and a second conductive material which is a fibrous carbon material,
D/G ratio of the first conductive material is 1.0 or less,
D/G ratio of the second conductive material is 0.5 or less, and
a ratio of the first conductive material to a total of the first conductive material and the second conductive material is 5% by mass or more and 30% by mass or less.

2. The cathode mixture according to claim 1, wherein the ratio of the first conductive material to the total of the first conductive material and the second conductive material is 8% by mass or more and 20% by mass or less.

3. The cathode mixture according to claim 1, wherein the first solid electrolyte is a sulfide solid electrolyte, and
the cathode active material is coated by a second solid electrolyte which is an oxide solid electrolyte.

4. A battery comprising a cathode active material layer, an anode active material layer, and an electrolyte layer disposed between the cathode active material layer and the anode active material layer,
wherein the cathode active material layer comprises the cathode mixture according to claim 1.

5. The battery according to claim 4, wherein the battery includes a control device configured to control a potential of the cathode active material layer to be equal to or higher than 4.0V (vs. Li/Li⁺) during charge.

6. A battery comprising a cathode active material layer, an anode active material layer, and an electrolyte layer disposed between the cathode active material layer and the anode active material layer,
wherein the cathode active material layer comprises the cathode mixture according to claim 2.

7. A battery comprising a cathode active material layer, an anode active material layer, and an electrolyte layer disposed between the cathode active material layer and the anode active material layer,
wherein the cathode active material layer comprises the cathode mixture according to claim 3.
